(19) United States
(12) Patent Application Publication
(10) Pub. No.: US 2022/0148421 A1
(43) Pub. Date: May 12, 2022

(54) Instrumented Traffic Cones for 5G/6G Networking

(71) Applicants: Esther S. Massengill, Palos Verdes, CA (US); R. Kemp Massengill, Palos Verdes, CA (US); David E. Newman, Palos Verdes, CA (US)

(72) Inventors: Esther S. Massengill, Palos Verdes, CA (US); R. Kemp Massengill, Palos Verdes, CA (US); David E. Newman, Palos Verdes, CA (US)

(21) Appl. No.: 17/584,787

(22) Filed: Jan. 26, 2022

Related U.S. Application Data
(60) Provisional application No. 63/240,459, filed on Sep. 3, 2021.
(60) Provisional application No. 63/286,176, filed on Dec. 6, 2021.

(51) Int. Cl. G08G 1/09; G08G 1/01; E01F 9/20; E01F 9/30; E01F 9/654

(52) U.S. Cl. CPC G08G 1/091; G08G 1/01; H04W 84/12; E01F 9/30; E01F 9/654; E01F 9/20

(57) ABSTRACT

An instrumented traffic cone provides visual demarcation of a passageway for vehicles or pedestrians, as well as a boundary around a facility such as a secure facility. Each instrumented traffic cone may be equipped with a sensor and a wireless communicator. The sensor may be a camera, an infrared detector, a lidar or radar or sonar or other sensor type. The wireless communicator may be configured for 5G or 6G communication, and may enable each instrumented traffic cone to report its measurement data to peers or to a supervisor, and to receive instructions from the supervisor or other instrumented traffic cones. The instrumented traffic cones may employ an AI-developed algorithm to form a self-organized network and to assign responsibilities among the instrumented traffic cones. By providing both visual guidance and sensor data by wireless communication, the instrumented traffic cones may enable improved control of many critical applications.

### PRIORITY CLAIMS AND RELATED APPLICATIONS

This application claims the benefit of U.S. Provisional Patent Application Ser. No. 63/240,459, entitled “Instrumented Traffic Cones for 5G Networking”, filed Sep. 3, 2021, and U.S. Provisional Patent Application Ser. No. 63/286,176, entitled “Instrumented Traffic Cones for 5G/6G Networking”, filed Dec. 6, 2021, all of which are hereby incorporated by reference in their entireties.

### FIELD OF THE INVENTION

The disclosure involves systems for monitoring vehicular traffic from multiple locations simultaneously and communicating results by wireless messaging.

### BACKGROUND OF THE INVENTION

Construction sites are difficult to manage. Heavy machinery may be in constant motion, the landscape may be changing, and the construction tasks may be evolving as the site progresses. What is needed is a low-cost means for monitoring traffic from multiple viewpoints simultaneously.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY OF THE INVENTION

In a first aspect, there is a demarcation device for demarking a lane of vehicular traffic, the demarcation device comprising: a visible shape comprising a pylon configured to be visible to vehicle drivers and autonomously operated vehicles; a weighted base; and electronics, comprising a wireless transmitter and receiver or alternatively comprising a transceiver, the electronics mounted in or on the upper visible shape or the weighted base or in portions of both, and configured for wireless communication with other demarcation devices.

In another aspect, there is a method for preparing a local network, the local network comprising a plurality of wireless devices, the method comprising: transmitting, by a first wireless device of the plurality, a wireless hailing message comprising an identification code of the first wireless device; receiving, by the first wireless device, a plurality of reply messages, each reply message transmitted by another wireless device of the plurality, each reply message comprising an identification code of the replying wireless device; and recording, in a memory of the first wireless device, the identification codes.

In another aspect, there is a traffic cone configured to demark a vehicle passage lane, the traffic cone configured to: sense or detect a vehicle passing proximate to the traffic cone; and transmit, to another traffic cone or to a base station, a wireless message indicating data related to the vehicle or the vehicle's passage.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

These and other embodiments are described in further detail with reference to the figures and accompanying detailed description as provided below.

### BRIEF DESCRIPTION OF THE DRAWINGS

FIG. 1 is a schematic sketch showing an exemplary embodiment of an instrumented traffic cone for communications, according to some embodiments.

FIG. 2 is a schematic sketch showing an exemplary embodiment of a construction site including instrumented traffic cones, according to some embodiments.

FIG. 3 is a schematic sketch showing an exemplary embodiment of an instrumented traffic cone for communications including power handling, according to some embodiments.

FIG. 4 is a schematic sketch showing an exemplary embodiment of a construction site including instrumented traffic cones including lanes, according to some embodiments.

FIG. 5A is a schematic sketch showing an exemplary embodiment of an array of instrumented traffic cones before forming an ad-hoc network, according to some embodiments.

FIG. 5B is a schematic sketch showing an exemplary embodiment of an array of instrumented traffic cones in communication, according to some embodiments.

FIG. 5C is a schematic sketch showing an exemplary embodiment of an array of instrumented traffic cones in an ad-hoc network, according to some embodiments.

FIG. 6 is a flowchart showing an exemplary embodiment of a procedure for instrumented traffic cones to self-organize, according to some embodiments.

Like reference numerals refer to like elements throughout.

### DETAILED DESCRIPTION

Disclosed herein is an instrumented traffic “cone” or “pylon” for guiding traffic, monitoring traffic, and wirelessly communicating data about the traffic. Systems and methods disclosed herein (the “systems” and “methods”, also occasionally termed “embodiments” or “arrangements”, generally according to present principles) can provide urgently needed wireless 5G/6G communication protocols to provide data on traffic motions, while also visually demarking lanes and roadways for vehicles, according to some embodiments.

The instrumented traffic cone may include a plastic, or other material, upper visible shape, attached to a weighted base, and usually made of a distinctive color such as red or orange, in some cases augmented by reflection tape or the like. The upper visible shape may be conical or cylindrical or rhomboid or prism-shaped or other pedestal-like shape readily visible to passing vehicles. The instrumented traffic cone may be portable and/or free-standing and/or not attached to anything. The traffic cone may include a lamp for enhanced visibility. Within the upper visible shape are one or more sensors configured to measure data about traffic proximate to the traffic cone, and electronics, such as a transmitter or transceiver or the like, to communicate the data wirelessly. The sensor(s) may include cameras, magnetic field sensors, laser or infrared light emitters and detectors, sound detectors and emitters, radar, sonar, lidar, among many other sensors suitable for measuring data about traffic proximate to the instrumented traffic cone. A window or portal or aperture or the like may be provided to enable the sensor to acquire the data and store it into, for example, a memory. The traffic cone may be configured to count the number of passing vehicles, or to record the time of passage, among other data. The transmitter or transceiver may include an antenna which may be internal to the upper visible shape or extending above it and configured to wirelessly transmit the data and, optionally, receive instructions. The instrumented traffic cones may form a local network, may determine their distribution spatially by measuring signal amplitudes or GPS coordinates or both, and may select a particular instrumented traffic cone as the leader or manager of the local network.

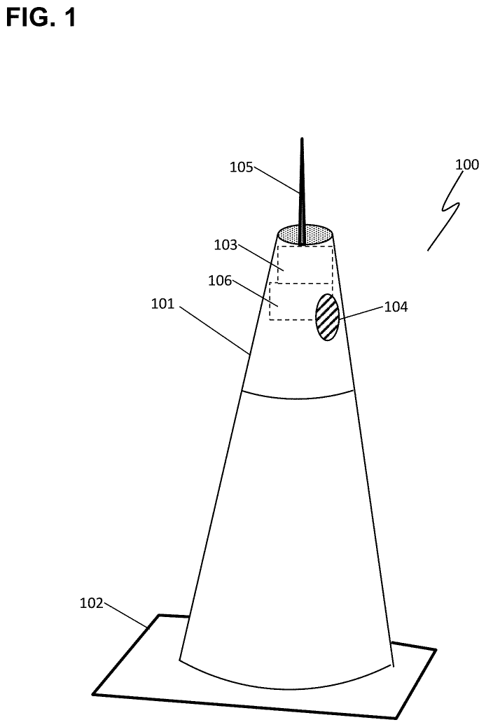

FIG. 1 is a schematic sketch showing an exemplary embodiment of an instrumented traffic cone for communications, according to some embodiments. As depicted in this non-limiting example, an instrumented traffic cone 100 may include an upper visible shape 101, which in this case is conical but may be any suitable shape, attached to a weighted base 102, which in this case is square but may be any suitable shape. Within the upper visible shape 101 is a wireless transceiver 103 and a sensor 106. A window 104, such as a transparent portion, is provided to allow the sensor 106 to make measurements, and an antenna 105 is attached to the transceiver 103 for transmitting and receiving messages. As an alternative, the upper visible shape 101 may be any shape suitable for demarking lanes visually. As an alternative, the weighted base 102 may be internal to the upper visible shape 101 instead of projecting laterally. As an alternative, the antenna 105 may be internal to the upper visible shape 101.

In some embodiments, the instrumented traffic cone 100 may be configured to be waterproof, weatherproof, and/or ruggedized, such as sufficiently rugged to withstand being dropped or subjected to other rough treatment.

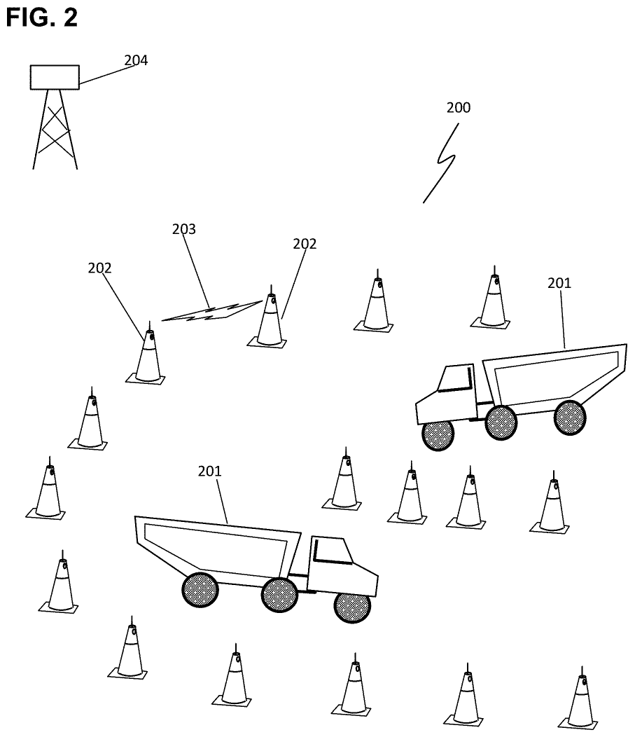

FIG. 2 is a schematic sketch showing an exemplary embodiment of a construction site including instrumented traffic cones, according to some embodiments. As depicted in this non-limiting example, a construction site 200 includes construction vehicles 201 and a plurality of instrumented traffic cones 202 arrayed to guide the construction vehicles 201 visually. In addition, the instrumented traffic cones are configured to measure data about the construction vehicles 201 and to communicate the data, or other data derived from it, wirelessly as shown by an icon 203.

For example, the instrumented traffic cones 202 may be configured to communicate among themselves to form a spontaneous local network, such as an ad hoc or trusted-neighbor or peer-to-peer network. For example, the instrumented traffic cones 202 may employ communication technologies such as 5G or 6G technologies, or Wi-Fi, or other short-range wireless communication technology.

In some embodiments, the instrumented traffic cones 202 may be configured to detect each vehicle 201 as it passes by. The instrumented traffic cones 202 may be configured to report vehicle passages to a supervisor elsewhere, for example through a base station 204. The instrumented traffic cones 202 may be configured to also measure the speed and/or direction of passage of each vehicle 201, among other data.

In some embodiments, the instrumented traffic cone may include a lamp or light for enhanced visibility. The lamp may be flashing. The lamp may indicate a condition such as an emergency condition or a failure, such as green steady lights indicating normal operation and red flashing lights indicating an emergency condition. The lamp may be mounted external to the upper visible shape, such as projecting above it and optionally integrated with the antenna, or the lamp may be mounted on or around the upper visible shape or the base. Alternatively, the upper visible shape may be made translucent and the lamp may be mounted inside, thereby causing the shape to light up at night. The system may further include a light sensor such as a sky sensor to determine when the sky is dark enough to turn on the lamp, and a switch to turn the lamp on and off.

In some embodiments, the transceiver may be configured to communicate with other wireless systems, such as those on the vehicles 201. For example, each instrumented traffic cone may be configured to self-protect by communicating with any vehicle 201 that comes too close, or that appears to be approaching, and may instruct the vehicle to either veer away or back up or otherwise stay in lane.

In addition, the instrumented traffic cones 202 may be in communication with an external manager and may be configured to act as a gate-keeper. For example, the manager may transmit a message to one of the instrumented traffic cones 202, instructing it to hold traffic for a period of time or to allow only one vehicle to pass per unit of time, among other commands. Then the instrumented traffic cone, upon detecting a passing vehicle, can transmit a message to the vehicle instructing it to hold position until the unit of time has passed, or whatever instructions the manager has provided. In this way, managers can control the traffic flow and other activities in the site more precisely and more closely than would be feasible, absent the instrumented traffic cones.

Instrumented traffic cones, as disclosed herein, may provide granular, real-time, specific data regarding activities at a construction site, as well as other sites involving demarked lanes and vehicles, and may thereby enable supervisors (including remote supervisors) to monitor and manage the site activities more effectively than possible, absent the instrumented traffic cones.

The instrumented traffic cones may be suitable for many other monitoring applications, such as demarking a temporary lane closure on a freeway. The instrumented traffic cones may be configured to detect any vehicles that attempt to violate the closure by driving between the instrumented traffic cones. The instrumented traffic cones may be arranged to demark a temporary walkway for pedestrians while counting the number of persons passing in each direction versus time, among many other applications involving moving entities along a demarked pathway.

The instrumented traffic cones may be arranged to guard a secure facility such as a prison or an airport. In the prison application, instrumented traffic cones surrounding the facility may detect an escapee, using a visible or infrared camera for example, or a beam of light interrupted by the passing individual, and may alert authorities including the precise time and location of passage. In the airport application, instrumented traffic cones, placed inside a fence, may detect intruders before they reach the tarmac, thereby preventing unauthorized access to planes or facilities.

In some embodiments, each instrumented traffic cone 202 may be configured to participate in a spontaneous local network (or ad hoc network) by transmitting messages to neighboring instrumented traffic cones, the messages including a unique identification code of each instrumented traffic cone 202. Each instrumented traffic cone 202 may be configured to determine its location relative to other instrumented traffic cones 202, for example by GPS or other satellite navigation system, or by measuring the intensity of signals from neighboring instrumented traffic cones 202, or using its sensor, or by detecting an externally supplied signal such as a manager signal, or otherwise. The spontaneous local network may be configured as a “sidelink” network of 5G/6G according to “mode-1” wherein an external base station manages messages between the instrumented traffic cones 202. Alternatively, the instrumented traffic cones 202 may be configured to select one instrumented traffic cone of a group to be an organizer or interface unit, for example according to a 5G/6G mode-2 sidelink network. For example, the organizer may be configured to accumulate messages or data from other instrumented traffic cones 202 in its group, and either analyze the accumulated data or transfer it to a supervisor entity or otherwise process the data.

In some embodiments, the instrumented traffic cones 202 may be configured to employ an algorithm to determine which of the instrumented traffic cones 202 in a region should belong to which group, and/or which instrumented traffic cone 202 of the group should be the organizer. The algorithm may be developed according to the geometrical distribution of the instrumented traffic cones 202 in the region, as well as the expected pathways of the vehicles or pedestrians, and other considerations. The algorithm may be developed using artificial intelligence (AI) or machine learning (ML), for example by selecting an optimal (or beneficial) size of each group as well as its particular members. As an option, the artificial intelligence may be developed as a software model in a quantum computer, which may be well-adapted to solving complex multi-parameter problems such as optimizing the adjustable variables in a large AI model. The groups may enclose separate territory, or the groups may be partially overlapping, depending on the type of application and the density of placement of the instrumented traffic cones.

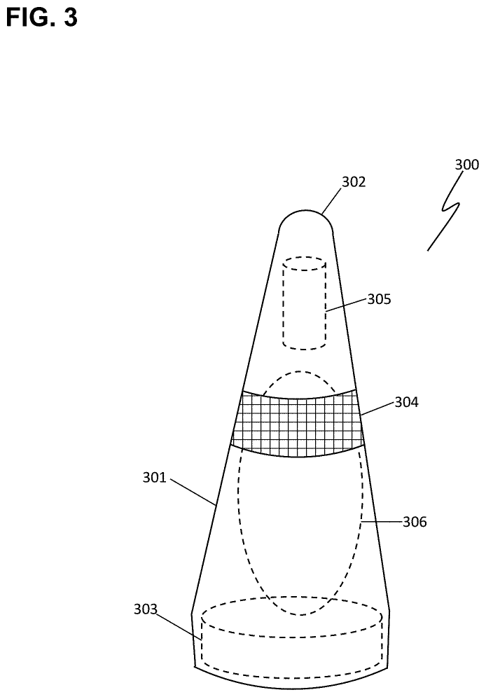

FIG. 3 is a schematic sketch showing an exemplary embodiment of an instrumented traffic cone for communications including power handling, according to some embodiments. As depicted in this non-limiting example, an instrumented traffic cone 300 may include a visible upper shape 301 with, in this case, a closure 302 at the top to keep rain out of the interior space. Instead of a lateral base, the instrumented traffic cone 300 now has an interior weight 303 which, in this case, is heavy enough to spontaneously right the cone if it is knocked over. The visible upper shape 301 is shaped to enable spontaneous self-righting.

The depicted example includes multiple optional power features, which may enable the instrumented traffic cone 300 to operate autonomously. A built-in or detachable solar panel 304, in this case wrapped around the visible upper shape 301, provides electricity to keep an internal battery 305 charged. Alternatively, an air bladder 306 is configured to generate power when the air pressure or temperature are changed, using a generator mechanism (not shown) driven by the expansion and contraction of the air bladder 306. As a further option, a thermocouple (not shown) connected between the weight 303 and the surrounding air may generate sufficient power due to temperature gradients, to charge the battery 305.

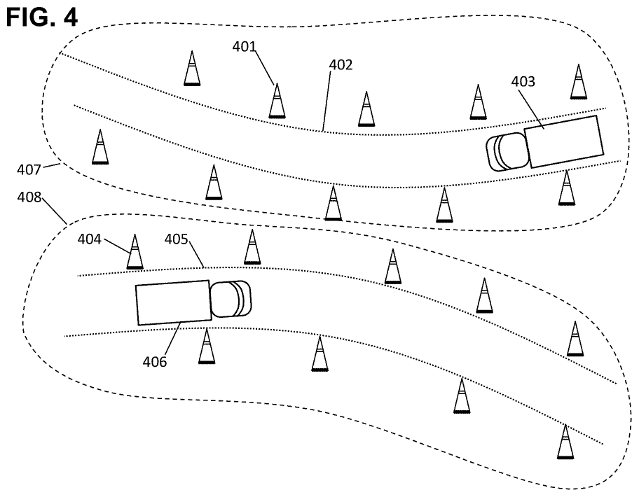

FIG. 4 is a schematic sketch showing an exemplary embodiment of a construction site including instrumented traffic cones including lanes, according to some embodiments. As depicted in this non-limiting example, a first array of instrumented traffic cones 401 is arranged on both sides of a first road 402, and a second array of instrumented traffic cones 404 is arranged on both sides of a second road 406. Two truck icons 403, 406 are shown on the roads 402, 405. The first array 401 has self-organized to form a first local network 407 (surrounded in dash) to monitor trucks 403 on the first road 402, and the second array 404 has self-organized as a second local network 408 to monitor trucks 406 on the second road 405. In this case, the instrumented traffic cones 401, 404 have communicated with each other to determine which ones are proximate to the first or second road 402, 405, and have thereby segregated themselves into the first or second network 407, 408. After joining the proper network 407, 408, each instrumented traffic cone 401, 404 can then report the motions of traffic 403, 406 on each road 402, 405 in real-time.

The traffic cones 401, 404 may have determined their spatial distribution relative to each other and/or to the roads 402, 405 using wireless signals based on signal amplitudes or directionality, and/or signals from an array of navigation satellites such as GPS. Alternatively, the traffic cones 401, 404 may have been placed, manually or by a machine, at particular locations and may have been informed of their locations by the entity that emplaced them, such as an administrator.

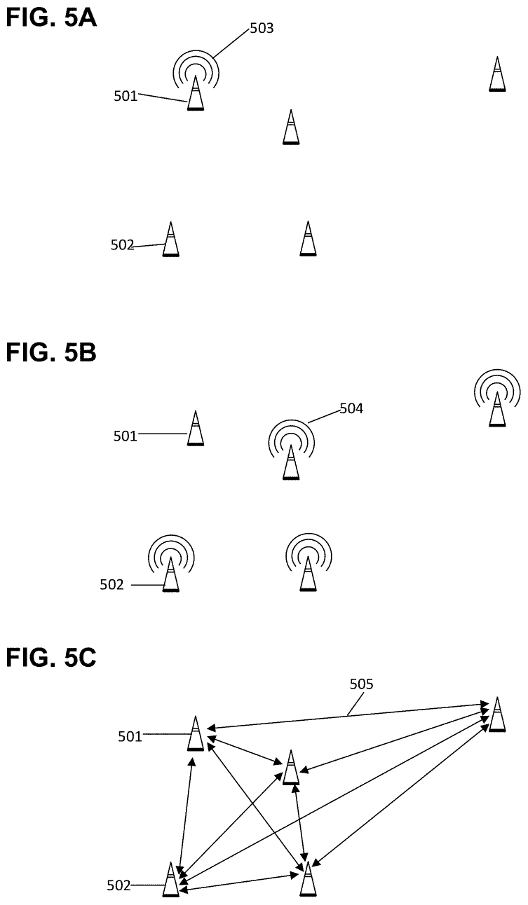

FIG. 5A is a schematic sketch showing an exemplary embodiment of an array of instrumented traffic cones before forming an ad-hoc network, according to some embodiments. As depicted in this non-limiting example, a first traffic cone 501, a second traffic cone 502, and others not labeled, are initially emplaced in a site and powered on. The first traffic cone 501 transmits a hailing message 503 on a common frequency, requesting a reply from any other instrumented traffic cones in range. The hailing message 503 includes the identification code of the first traffic cone 501 as well as an indication that the message 503 is a hailing message, or that a reply is requested.

FIG. 5B is a schematic sketch showing an exemplary embodiment of an array of instrumented traffic cones in communication with each other, according to some embodiments. As depicted in this non-limiting example, the second traffic cone 502, and the others, have received the hailing message from the first traffic cone 501. After a random delay, each of the traffic cones has transmitted a reply message such as 504. The reply delays are randomly selected. Each traffic cone monitors the common frequency to avoid collisions. Therefore, each of the reply messages 504 is transmitted sequentially. Each reply message 504 includes the identification code of the replying traffic cone. The first traffic cone 501, upon receiving the reply messages 504, may then know the identification codes of each of the proximate traffic cones. Likewise, each of the traffic cones can determine, from the hailing message 503 and the reply messages 504, the identification codes of all the traffic cones in the area. The traffic cones can then communicate with each other explicitly, that is, unicast, by including the identification code of the intended recipient in a message. The traffic cones have thereby formed a spontaneous local network, and can then cooperate in performing tasks, such as traffic monitoring.

FIG. 5C is a schematic sketch showing an exemplary embodiment of an array of instrumented traffic cones in an ad-hoc network determining their relative positions based on signal amplitudes, according to some embodiments. As depicted in this non-limiting example, the first and second traffic cones 501, 502, and the others, have already communicated with each other and formed a local network. In addition, each of the traffic cones has measured the received signal amplitude of the hailing message from the first traffic cone 501, and has recorded that value. The first traffic cone 501 has recorded the amplitude of the reply messages 504 from each of the other traffic cones along with their stated identification codes. Each of the other traffic cones has also received the reply messages of the other traffic cones and has recorded the received signal amplitudes along with their identification codes. Each of the traffic cones then transmits, to the first traffic cone 501, messages indicating the signal amplitude received from each of the other traffic cones, including the hailing message and the reply messages.

The first traffic cone 501 can then analyze all those signal amplitude measurements together, and can thereby determine the distances 505 between the traffic cones, and thereby determine a self-consistent two-dimensional map of the positions of the various traffic cones in the network. Since the amplitude of a wireless message decreases according to the distance traveled, the signal amplitude is a measure of the distance between the transmitter and receiver. The first traffic cone 501 can then prepare a two-dimensional map according to the various distances 505 as measured by their measured signal amplitudes.

Then, using the two-dimensional map, the first traffic cone 501 can determine which of the traffic cones is closest to a centroid, or other central point, of the distribution. The first traffic cone can transmit a message to that central traffic cone and declare that the central traffic cone is now the leader of the network since, being centralized, the central traffic cone may be able to communicate most readily with the other traffic cones in the network. The central traffic cone can then assume responsibilities for managing the other traffic cones in the network, communicating results to a base station or administrator, and other tasks.

In another embodiment, the hailing traffic cone may retain the leadership responsibility, or may hand it to another traffic cone that is better equipped to perform the leadership tasks. A traffic cone that is not equipped to assume the leadership responsibilities may refrain from transmitting a hailing message, thereby allowing a more capable traffic cone to do so, and to become the leader. However, all of the instrumented traffic cones receiving the hailing message are expected to transmit a reply, according to some embodiments.

In some embodiments, the various traffic cones may have different transmission power levels and different receiver efficiencies. In that case, each received amplitude level is related to the distance according to a different proportionality. However, there may be enough information in the measurements to enable the first traffic cone 501 to correct for those variations, for example by comparing the measurements of different combinations of traffic cones. For example, the signal level transmitted by the first traffic cone 501 and received by the second traffic cone 502 should be the same as the signal level transmitted by the second traffic cone 502 and received by the first traffic cone 501, and any differences may indicate a difference in transmitted power or receiver sensitivity between the two traffic cones 501, 502. Likewise, a particular transmission, such as the hailing message 503, may be received by each of the other traffic cones with an amplitude related to their distance from the first traffic cone 501, and any variation from that formula may be due to variations in the receiver sensitivities of the traffic cones. In addition, the amplitude of the reply messages, from each of the traffic cones, as received at the first traffic cone 501, should be related to the distances except for variations in transmitted power. By applying these constraints to all of the transmitted signals and received signals, the first traffic cone 501 can separate variations in power and sensitivity from the inter-cone distances in the network, and thereby determine the two-dimensional map of traffic cone positions relative to each other, according to some embodiments.

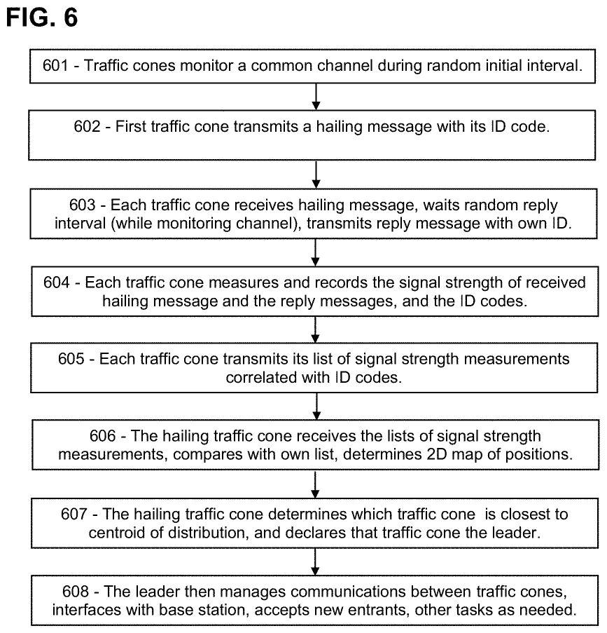

FIG. 6 is a flowchart showing an exemplary embodiment of a procedure for instrumented traffic cones to self-organize, according to some embodiments. As depicted in this non-limiting example, instrumented traffic cones self-organize in a local network and select a centrally located leader, based on signal amplitudes received from each other. Determining the relative positions based on the received amplitudes of signals transmitted between the traffic cones may be simpler and less costly than adding a GPS receiver in each of the traffic cones. In addition, there are many locations where satellite signals are obscured or otherwise inappropriate.

At 601, an array of instrumented traffic cones initially monitors a common channel to detect any messages, such as hailing messages, that another traffic cone may transmit. They continue monitoring for a random initial interval, chosen differently for each of the traffic cones involved. At 602, one of the traffic cones determines that its random initial interval of monitoring has expired with no transmissions detected, and therefore transmits a hailing message configured to elicit a reply from each other traffic cone in range. The hailing message also indicates the identification code of the first traffic cone, so that the other traffic cones can contact the first traffic cone specifically. At 603, each of the traffic cones receives the hailing message, and then waits a random reply delay before transmitting a reply message, which may include the identification code of the replying traffic cone. In addition, each traffic cone can monitor the common channel to detect the reply messages of other traffic cones, record their identification codes. The traffic cones can also check that the channel is clear before transmitting to avoid collisions.

At 604, each traffic cone measures the signal amplitude that it receives for the hailing message and each subsequent reply message, along with the identification codes of each other traffic cone. At 605, the various traffic cones transmit their signal amplitude measurements to the first traffic cone, along with the identification code of the traffic cone that transmitted each of the measured signal amplitudes. At 606, the first traffic cone receives the lists of signal amplitudes and the associated identification codes, for each message received by each of the traffic cones. At 607, the first traffic cone analyzes the data, correlating signal amplitudes with each specific traffic cone, and determines a two-dimensional map of relative positions of the traffic cones in the network.

At 607, the first traffic cone determines, from the two-dimensional map, which of the traffic cones is closest to a centroid, or other central feature, of the distribution of traffic cones, and then transmits a message to that central traffic cone declaring the central traffic cone to be the network leader. (Alternatively, it could select the most competent traffic cone, or one that had been prepared for leadership tasks, or other selection criterion.) Thereafter, at 608, the new leader assumes responsibilities for managing the network, such as accumulating sensor data and the like, passing the data to a base station or administrator, receiving instructions from the administrator, and arranging for the various traffic cones in the network to perform the requested tasks. In some embodiments, the leader may also arrange a resource grid of frequencies and symbol times, provide grants for the various traffic cones to transmit, and other tasks associated with a 5G/6G mode-2 sidelink network. In other embodiments, the leader may allow each of the traffic cones to transmit at will.

The wireless embodiments of this disclosure may be aptly suited for cloud backup protection, according to some embodiments. Furthermore, the cloud backup can be provided cyber-security, such as blockchain, to lock or protect data, thereby preventing malevolent actors from making changes. The cyber-security may thereby avoid changes that, in some applications, could result in hazards including lethal hazards, such as in applications related to traffic safety, electric grid management, law enforcement, or national security.

In some embodiments, non-transitory computer-readable media may include instructions that, when executed by a computing environment, cause a method to be performed, the method according to the principles disclosed herein. In some embodiments, the instructions (such as software or firmware) may be upgradable or updatable, to provide additional capabilities and/or to fix errors and/or to remove security vulnerabilities, among many other reasons for updating software. In some embodiments, the updates may be provided monthly, quarterly, annually, every 2 or 3 or 4 years, or upon other interval, or at the convenience of the owner, for example. In some embodiments, the updates (especially updates providing added capabilities) may be provided on a fee basis. The intent of the updates may be to cause the updated software to perform better than previously, and to thereby provide additional user satisfaction.

The systems and methods may be fully implemented in any number of computing devices. Typically, instructions are laid out on computer readable media, generally non-transitory, and these instructions are sufficient to allow a processor in the computing device to implement the method of the invention. The computer readable medium may be a hard drive or solid state storage having instructions that, when run, or sooner, are loaded into random access memory. Inputs to the application, e.g., from the plurality of users or from any one user, may be by any number of appropriate computer input devices. For example, users may employ vehicular controls, as well as a keyboard, mouse, touchscreen, joystick, trackpad, other pointing device, or any other such computer input device to input data relevant to the calculations. Data may also be input by way of one or more sensors on the robot, an inserted memory chip, hard drive, flash drives, flash memory, optical media, magnetic media, or any other type of file-storing medium. The outputs may be delivered to a user by way of signals transmitted to robot steering and throttle controls, a video graphics card or integrated graphics chipset coupled to a display that maybe seen by a user. Given this teaching, any number of other tangible outputs will also be understood to be contemplated by the invention. For example, outputs may be stored on a memory chip, hard drive, flash drives, flash memory, optical media, magnetic media, or any other type of output. It should also be noted that the invention may be implemented on any number of different types of computing devices, e.g., embedded systems and processors, personal computers, laptop computers, notebook computers, net book computers, handheld computers, personal digital assistants, mobile phones, smart phones, tablet computers, and also on devices specifically designed for these purpose. In one implementation, a user of a smart phone or Wi-Fi-connected device downloads a copy of the application to their device from a server using a wireless Internet connection. An appropriate authentication procedure and secure transaction process may provide for payment to be made to the seller. The application may download over the mobile connection, or over the Wi-Fi or other wireless network connection. The application may then be run by the user. Such a networked system may provide a suitable computing environment for an implementation in which a plurality of users provide separate inputs to the system and method.

It is to be understood that the foregoing description is not a definition of the invention but is a description of one or more preferred exemplary embodiments of the invention. The invention is not limited to the particular embodiments(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the specific combination and order of steps is just one possibility, as the present method may include a combination of steps that has fewer, greater, or different steps than that shown here. All such other embodiments, changes, and modifications are intended to come within the scope of the appended claims.

As used in this specification and claims, the terms “for example”, “e.g.”, “for instance”, “such as”, and “like” and the terms “comprising”, “having”, “including”, and their other verb forms, when used in conjunction with a listing of one or more components or other items, are each to be construed as open-ended, meaning that the listing is not to be considered as excluding other additional components or items. Other terms are to be construed using their broadest reasonable meaning unless they are used in a context that requires a different interpretation.

1. A demarcation device for demarking a lane of vehicular traffic, the demarcation device comprising:
a. a visible shape comprising a pylon configured to be visible to vehicle drivers and autonomously operated vehicles;
b. a weighted base; and
c. electronics, comprising a wireless transmitter and receiver or alternatively comprising a transceiver, the electronics mounted in or on the upper visible shape or the weighted base or in portions of both, and configured for wireless communication with other demarcation devices.

2. The demarcation device of claim 1, wherein the wireless communication is according to 5G or 6G technology.

3. The demarcation device of claim 1, further comprising a sensor, mounted in or on the upper visible shape or the weighted base, and configured to measure or detect an object proximate to the demarcation device.

4. The demarcation device of claim 3, further comprising a window or aperture configured to admit signals or images or energy which the sensor is configured to detect.

5. The demarcation device of claim 1, further comprising an antenna operably connected to the electronics and mounted within the upper visible shape or projecting above the upper visible shape, and configured to transmit and receive wireless messages.

6. The demarcation device of claim 1, further comprising an energy source mounted in or on the upper visible shape or the weighted base, and configured to power the electronics.

7. The demarcation device of claim 6, wherein the energy source is at least one of:
a. a photoelectric cell or an array of photoelectric cells;
b. a battery;
c. a thermocouple;
d. a gas-filled enclosure; and
e. combinations of these.

8. The demarcation device of claim 1, further comprising a lamp mounted in or on the upper visible shape.

9. The demarcation device of claim 1, configured to detect a vehicle or pedestrian passing proximate to the device.

10. The demarcation device of claim 9, further configured to record data related to the vehicle or pedestrian passing, the data comprising at least a count or a time.

11. The demarcation device of claim 1, configured to transmit a hailing message to other demarcation devices, the hailing message comprising at least an identification code of the hailing device.

12. The demarcation device of claim 1, configured to receive a hailing message transmitted by another demarcation device, and to transmit a reply message comprising at least an identification code of the replying demarcation device.

13. The demarcation device of claim 1, configured to receive one or more messages transmitted by other demarcation devices, and to measure an amplitude of each of the received messages.

14. The demarcation device of claim 13, further configured to determine a distance corresponding to each amplitude, and to determine a spatial distribution of the plurality of demarcation devices according to the distances.

15. A method for preparing a local network, the local network comprising a plurality of wireless devices, the method comprising:
a. transmitting, by a first wireless device of the plurality, a wireless hailing message comprising an identification code of the first wireless device;
b. receiving, by the first wireless device, a plurality of reply messages, each reply message transmitted by another wireless device of the plurality, each reply message comprising an identification code of the replying wireless device; and
c. recording, in a memory of the first wireless device, the identification codes.

16. The method of claim 15, further comprising measuring, by the first wireless device, a received signal amplitude or power associated with each reply message.

17. The method of claim 16, further comprising determining, based at least in part on the measured amplitude or power, a respective distance between the first wireless device and each of the replying wireless devices.

18. The method of claim 17, further comprising determining, based at least in part on the distances, a centrally positioned wireless device, and declaring the centrally positioned wireless device to be a leader or manager of the local network.

19. A traffic cone configured to demark a vehicle passage lane, the traffic cone configured to:
a. sense or detect a vehicle passing proximate to the traffic cone; and
b. transmit, to another traffic cone or to a base station, a wireless message indicating data related to the vehicle or the vehicle's passage.

20. The traffic cone of claim 19, further configured to detect an approaching vehicle and to transmit a message to the vehicle instructing the vehicle to change course.
